(19) United States
(12) Patent Application Publication
(10) Pub. No.: US 2009/0055753 A1
(43) Pub. Date: Feb. 26, 2009

(54) Method and arrangement for supporting a user and a user group

(76) Inventors: Ana Balevic, Munchen (DE); Bruno Bozionek, Borchen (DE); Markus Gerstel, Haimhausen (DE); Adriano Pastore, Munchen (DE); Manuela Schauer, Ottobrunn (DE)

Correspondence Address: Siemens Corporation;Intellectual Property Department, 170 Wood Avenue South, Iselin, NJ, 08830, US

(21) Appl. No.: 11/894,072

(22) Filed: Aug. 20, 2007

(51) Int. Cl. G06F 3/00

(52) U.S. Cl. 715/747

(57) ABSTRACT

In one aspect a method for supporting a user in a user group, where the user has a mobile information appliance available, and where a user profile with user-specific preferences is input into a database by the user or for the user is provided. In this case, the user is assigned to at least one subgroup of the user group on the basis of the user profile, and the members of the subgroup are displayed to the user by means of the information appliance. A further important aspect is the option of writing and publishing experience reports, with other users being able to rate these reports and the prospect of advantages being held out to the author on the basis of the ratings.

### FIELD OF INVENTION

The present invention relates to a method and arrangement for supporting a user and a user group.

### BACKGROUND OF INVENTION

Users in user groups frequently need to be provided with a large amount of information individually which is the same for all users. This relates particularly to members of relatively large tour groups who are staying on a cruise ship or are guests at an extended hotel facility, for example. It also applies to visitors at a congress, a trade fair or other events, however. By way of example, that information which relates to all users is distributed in the form of a printed brochure, is published on pin boards or is made available to all users equally in electronic form, for example by means of a website. However, it is the case that not all available information is of equal interest to all users. This is a drawback particularly when the total volume of information is very large while the volume of information which is of interest to the individual users is only a fraction thereof.

Another problem is that large user groups with many individual users often need to be divided into “subgroups”, which, in the case of large events or on the aforementioned cruise ships, is usually done by virtue of participants in outings, participants in workshops or the like entering themselves into lists on display by hand or registering at a service point, a reception or a similar contact point. In brief, organizing an event with a large number participants (users) is complex both on the part of the users and on the part of an organization team if a smooth procedure is intended to be guaranteed. Added to this is the fact that such events frequently take place at locations which are not known to the individual participants (users). By way of example, modern cruise ships are often so large that the individual passenger can easily lose track. A similar situation applies for large congress centers and trade fair facilities. It should also be considered that a person who cannot describe his current location correctly is also unable to make exact statements about his location in the event of an emergency call, for example using a mobile telephone.

### SUMMARY OF INVENTION

It is an essence of the invention to provide the users in a user group with a respective electronic, mobile information appliance which both simplifies geographical orientation for this user and provides him with the information which is specifically of interest to him. In addition, the formation of groups of users with common interests is intended to be simplified thereby. What are involved are thus a method and technical facilities which ensure IT support for a user in a user group as comprehensively as possible.

In particular, the invention proposes a method for supporting a user in a user group, where the user has a mobile information appliance available, where a user profile with user-specific preferences is input into a database by the user or for the user, where the user is assigned to at least one subgroup of the user group on the basis of the user profile, and where the members of the subgroup are displayed to the user by means of the information appliance.

The use of such a method makes it easier for a tour guest or a congress visitor or a trade fair visitor or the like to find other people with similar interests.

To solve the problems, the invention also proposes developing a piece of software for such a mobile information appliance, the software being set up to carry out the method. In cases in which a user already has his own electronic information appliance, said appliance can just be provided with the software, but this software can also be executed on a server. In these cases, a web browser or a similar piece of software on an electronic (mobile) information appliance suffices in order to provide the appropriate functionality.

As a counterpart, the software for the information appliance thus also has an associated piece of server-based software which, by way of example, performs or at least allows the access to the user-specific preferences of other users.

As an alternative to the solution in which a user provides his own information appliance, it is naturally also possible for any user from the user group to be provided with such an information appliance, which is set up to carry out the method, at least for the duration of the event or trip.

A fundamental advantage is obtained if the services provided on a trip or in the course of an event or the available facilities are described or commented upon by the users themselves, for example in the form of a web log(blog) or in the manner of a short rating, as are customary in the case of online auctions. The comments which are input by the users in this context can be read or viewed by the other users after they have been published. In this case, it is advantageous if the users reading the comments rate the comments themselves, for example using what is known as a ranking. This involves at least distinguishing between a positive rating and a negative rating (e.g. “helpful” or “obsolete”); advantageously, finer grading is used, for example using a points system between zero and ten points or the like. As an incentive to comment truthfully and in detail upon services or facilities used, the users submitting these comments can be provided with the prospect of a “reward”, that is to say an advantage. By way of example, a user who frequently publishes comments which are rated as “helpful” by many other users can be rewarded with a price reduction for the future use of a service.

A further advantage is obtained if the information appliance can be used for navigation. Thus, a user who carries his information appliance with him on a “land outing” or other excursion can use a GPS receiver in the information appliance and a (local) map stored therein to find his way back to the ship or to the hotel or to the event location. However, it is also possible to locate the information appliance within a building or a ship, for example by means of triangulation using various radio base stations (for example WLAN hotspots or DECT transmitters). It is thus also possible to perform routing in complex buildings or on large ships. Another advantage of location, regardless of whether it is performed on the network or on the appliance, is in emergency situations. Thus, a user can use his information appliance, which preferably comprises a bidirectional communication option, to send an emergency call, with the geographical position of the information appliance being ascertained automatically, so that a user in need of help can easily be found.

These and other particular embodiments are described below in detail in conjunction with the drawings which follow.

### BRIEF DESCRIPTION OF THE DRAWINGS

in the drawings:

FIG. 1 shows a schematic illustration of an arrangement based on the invention in which the support for a user (tourist) is shown, and

FIGS. 2a, 2b show examples of data systems messages which are interchanged by an information appliance and a central server, together with identification numbers for the data systems messages.

### DETAILED DESCRIPTION OF INVENTION

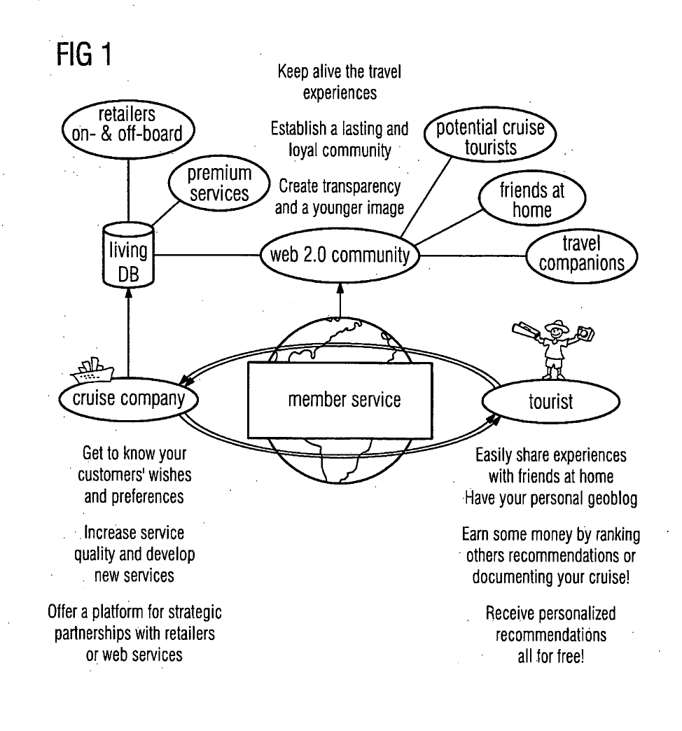

For the exemplary embodiment which follows, the user group is considered to be the passengers (=user group) on a cruise ship. It goes without saying that the invention described can also be applied to other user groups, as described further above, for example trade fair visitors, event visitors etc. Every passenger (tourist) has a mobile, electronic information appliance, in this case a PDA with a WLAN facility. With this information appliance, the user is constantly connected “online” to a server which is connected to the WLAN data network of the cruise ship. This server is also used to connect a database from the operator of the ship. In addition, any users of the Internet can access particular public contents on the server. The arrangement is shown schematically in FIG. 1, with a few functionalities also being shown by way of example.

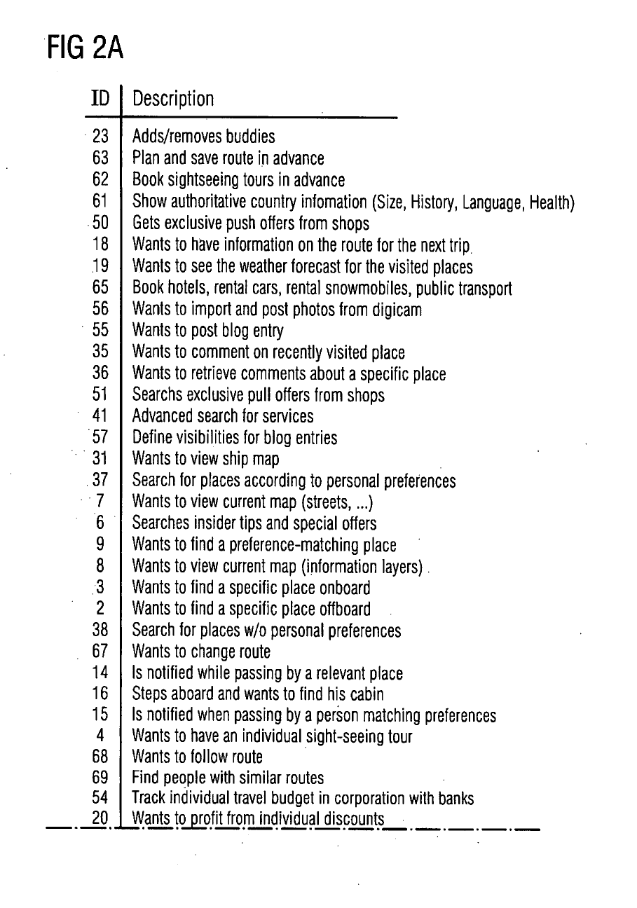

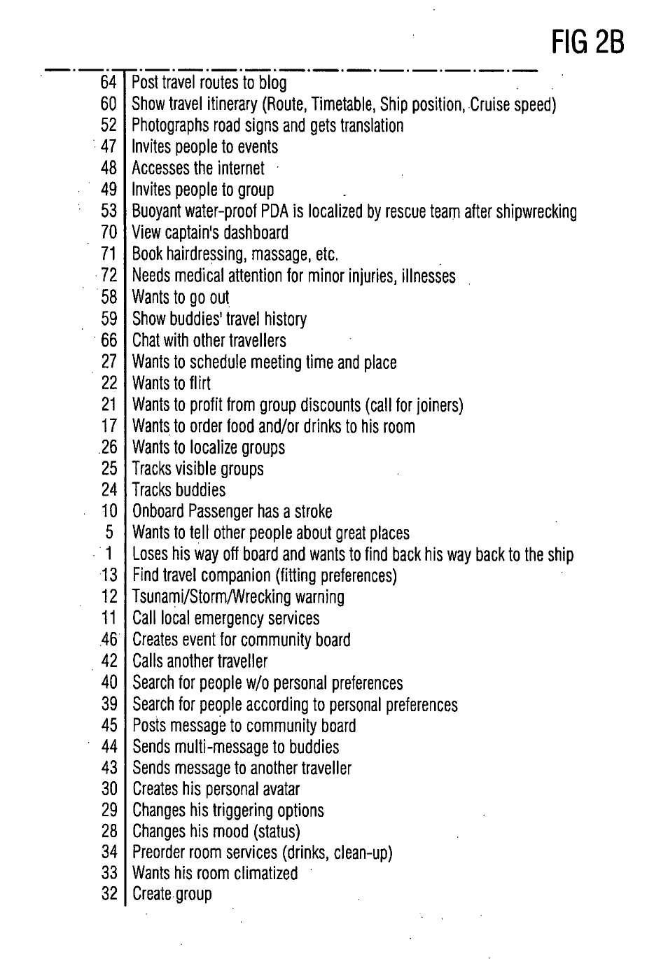

The method explained within the context of this exemplary embodiment is based on the user using his information appliance to use services which are either provided by the central server or can be obtained (accessed) via it. To this end, the information appliance and the central server or its database interchange messages, a few of which are shown by way of example in FIGS. 2a, 2b with the associated identification numbers. The list of messages described there and the use options resulting therefrom are not enumerated conclusively; rather, they are examples of possible services.

In principle, the available services can be divided into functional groups, of which one group relates to the organization of the travelers into “communities”, which bring together travelers with the same or similar interests, on the basis of “personal profiles”. Another group relates to functions which are based on the electronic equivalent of a personal tour guide, with travel information in turn being compiled and tours recommended on the basis of the “personal profiles”, both for the individual traveler and for a (previously organized) community. Another function group relates to a (central) information and knowledge database in which personal experiences of the travelers regarding tours, events (on board/off board) and services/facilities are documented and made available to others, this also including a rating system for the entries in the information and knowledge database. Another group of functions relates to (geographical) navigation both on the cruise ship (on board) (or at another event location) and outside of it (off board). Another, important group relates to emergency management; this combines functions such as emergency calls (communication), position finding and warning (alerts, alarms). While the latter function group should be available to every user, the other functions, particularly packaged as function groups, can be enabled separately for individual users (participants, travelers, passengers), for example in return for a fee. It goes without saying that the availability of individual functions is also dependent on the hardware used (the information appliance used), with, by way of example, “off board” navigation being dependent on the presence of a GPS receiver or of a similar facility, while in the case of “on board” navigation it is possible for the position of the information appliance to be found by the radio base stations there (WLAN, DECT or the like) and hence generally regardless of the hardware used. The same applies to the communication functions, which are naturally dependent both on the information appliance used and on the infrastructure available at the respective location.

Many functions in connection with the outlined methods are dependent on a user (traveler) providing the most detailed information possible about himself or about his preferences, this information being recorded in the central database (“living DB”). Preferably, the user uses a suitable dialog, for example a browser-aided input dialog, to input this information into his information appliance, this information being transmitted to a central server “online” via an available data network (for example WLAN) and being input into the database by said central server. Alternatively, such information can also be picked up by third parties, for example by the personnel on a cruise ship, and put into the database by said personnel. Finally, the profile data (“personal profiles”) can also be reused by those users who have already provided such information on a previous trip or at another “event”.

After this process, the traveler has the option of using his information appliance to send a query to the database providing him with information about fellow travelers who have likewise enabled this function for their “profile data”. In this case, preferably those fellow travelers who have indicated the same or similar preferences or mutually compatible preferences are selected (displayed). Advantageously, the fellow travelers displayed are then displayed with a photo or similar identification feature (symbol, nickname), so that the travelers grouped on the basis of the profile data can recognize one another. The groups compiled in this manner can also be selected specifically for one or more particular purposes, for example in the case of interest in the same cultural event etc.

On the basis of the same data record, namely the personal preferences (“personal profiles”), the user (traveler) can also be presented with information or be provided with different proposals for events, tours etc. which are not directly connected to other travelers. This advantageously involves the current position of the traveler (and hence of the information appliance) or the current position of the cruise ship or the like, so that the user/traveler receives helpful information on the basis of the current geographical position, said information also including, by way of example, current natural events, currently close attractions, country-specific information, weather advice, restaurant advice etc. In this case, the information appliance's software or the software on the server can be switched between “individual function” and “group function”. In contrast to the “individual function”, the “group function” highlights such advice and proposals as are advantageous or suitable for a respectively defined group (community). Thus, by way of example, an outing group of 20 people does not receive any proposals for a pub/restaurant which has only 10 seats. Similarly, particular consideration can be given to the needs of disabled participants/users.

The participants/travelers have the option of documenting and commenting upon services, facilities, tours etc. which they use in the form of reports, comments or electronic journals (web “blogs”). Advantageously, the information appliance also has a photo or video function for this purpose, and image and sound documents produced by this means can likewise be included in the comments or reports. In this context, the user/traveler is advantageously motivated to write truthful, helpful reports/comments by virtue of other users/participants/travelers having the option of rating the reports, comments etc. written. In the present exemplary embodiment, this is done using a “ranking” of between “0” and “10” points (or stars); naturally, other gradings are also possible, for example “very helpful”-“helpful”-“not very helpful”-“not helpful” or the like. In this case, users are granted an advantage on the basis of the frequency and helpfulness of their submitted comments/reports, for example in the form of material awards, cheaper rates for using services and facilities, or participation in a competition.

The reports/comments can also be enabled for people outside of the travel community, for example through the Internet. Optionally, such external people can also be provided with the same or another option of rating the entries. By way of example, a tour operator can use the furnished reports/comments for additionally describing its offerings, and on the other hand it is possible for interested parties to benefit from the experience reports from past trips/events.

Position finding for the information appliance is possible within a limited physical area, for example on a cruise ship or on trade fair premises, using a network-based infrastructure. Appropriate methods are known, by way of example, as reception-field-strength-oriented triangulation by means of a plurality of simultaneously obtainable radio base stations. Outside of enclosed spaces, satellite-aided position finding, for example by the GPS satellite system, is also possible. Hence, the information appliance can either determine information about its own position itself or can receive it from a network-based infrastructure. Together with either a map which is stored in the information appliance or geographical/physical information which is available on the server, comprehensive navigation is therefore possible using the information appliance. This assists a user (traveler) both in situations in which he needs to orientate himself “on board” on the cruise ship/at the event location and “off board” in the case of land outings etc. In the case of an emergency call, such information can also be transmitted automatically to an emergency call center, so that a user/traveler in distress can easily be found. In the case of an emergency, for example a natural catastrophe or a ship evacuation etc., it is also possible for the traveler to be routed to the closest meeting point, lifeboat, emergency exit etc. by means of the information appliance designed in this fashion. In addition, an “@home key” is advantageously set up which navigates the user/traveler to the cruise ship or event location on the fastest/shortest route in the case of land outings, for example.

1. A method for supporting a user in a user group,
inputting a user profile with user-specific preferences into a database;
assigning the user to at least one subgroup of the user group on the basis of the user profile; and
displaying members of the subgroup on a mobile information appliance of the user by means of the information appliance.

2. The method as claimed in claim 1,
wherein the user uses the information appliance to input experience reports about the facilities or about available services into a database, and
wherein the experience reports are available for retrieval by other members of the user group via an information appliance of the respective other member.

3. The method as claimed in claim 2,
wherein each user in the user group can rate the experience reports from the other users, and
wherein the rating being stored in the database and the rating being able to be retrieved by all users.

4. The method as claimed in claim 3,
wherein rating an experience report involves at least distinguishing between a positive rating and a negative rating, an author of the rated experience report being granted an advantage for the future use of facilities, services or another advantage on the basis of the ratings for the experience report written by the author.

5. The method as claimed in claim 1, wherein a tour group is equipped with a plurality of mobile information appliances as a user group.

6. The method as claimed in claim 1, wherein an information appliance with a navigation function is used.

7. The method as claimed in claim 5, wherein the user is provided with position-related information by means of the information appliance.

8. The method as claimed in claim 1, wherein the user receives commercial and non-commercial offer proposals on the basis of the user profile.

9. The method as claimed in claim 1, wherein the information appliance can be used to send an emergency call.

10. The method as claimed in claim 9, where a position statement for the information appliance can be sent automatically together with the emergency call.

11. A mobile information arrangement, comprising:
a database having a plurality of user profiles for a plurality of users such that each user profile associated with a user; and
a plurality of information appliances, each appliance:
associated with at least one of the users,
includes wireless transmission,
designed to aid locatability for respective information appliance, and
includes a communication function
wherein each user is assigned to at least one subgroup based on the respective user profile, and
wherein for a user assigned to subgroup, the associated information appliance is designed to display other members of a subgroup to the respective user.

12. The arrangement as claimed in claim 11,
wherein the user uses the information appliance to input experience reports about the facilities or about available services into a database, and
wherein the experience reports are available for retrieval by other members of the user group via an information appliance of the respective other member.

13. The arrangement as claimed in claim 12,
wherein each user in the user group can rate the experience reports from the other users, and
wherein the rating being stored in the database and the rating being able to be retrieved by all users.

14. The arrangement as claimed in claim 13,
wherein rating an experience report involves at least distinguishing between a positive rating and a negative rating, an author of the rated experience report being granted an advantage for the future use of facilities, services or another advantage on the basis of the ratings for the experience report written by the author.

15. The arrangement as claimed in claim 11, wherein a tour group is equipped with the plurality of mobile information appliances as a user group.
